(19) United States
(12) Patent Application Publication
(10) Pub. No.: US 2011/0205840 A1
(43) Pub. Date: Aug. 25, 2011

(54) SEISMIC EQUIPMENT HANDLING

(76) Inventor: Robert W. Hayes, Maurice, LA (US)

(21) Appl. No.: 12/708,577

(22) Filed: Feb. 19, 2010

(51) Int. Cl. G01V 1/38

(52) U.S. Cl. 367/20

(57) ABSTRACT

Launch and retrieval equipment for use in seismic testing and methods for seismic testing are described. Elements of the equipment may include a pivoting frame to hold the seismic equipment, sliding rails that hold the seismic equipment in place on the frame and a winch and line that operates to launch the seismic equipment keeping it tethered to a vessel. The launch device is capable of launching and retrieving seismic equipment without the use of conventional cranes.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND

Deploying and retrieving seismic equipment to and from marine vessels for seismic testing by conventional overhead lifting presents significant risks to both equipment and personnel. Much of this risk is associated with the use of cranes in deployment and retrieval. Developments in seismic testing procedures and equipment have failed to adequately address these concerns.

Information having potential relevance to attempts to address these limitations can be found in U.S. Pat. No. 6,955,519 to Ferderber entitled “Davit System for Lifting Boats, Jet Skis, Motorcycles and the like;” U.S. Pat. No. 6,178,914 to Axelsson entitled “Method and an Arrangement for Launching and Taking Aboard a Raft;” U.S. Pat. No. 6,182,595 to Morris entitled “Pivoting Docking Platform for Personal Watercraft;” U.S. Pat. No. 3,895,592 to King entitled “Boat Lift;” U.S. Pat. No. 2,398,274 to Albert entitled “Device for Launching and Retrieving Boats;” U.S. Pat. No. 6,289,837 to Stetzel entitled “Roller Rack Device;” U.S. Pat. No. 5,855,180 to Masters entitled “Tilting Dry Dock for Small Watercraft;” U.S. Pat. No. 3,937,163 to Rosenberg entitled “Launch and Recovery Vessel;” U.S. Pat. No. 3,943,875 to Sanders entitled “Method and Apparatus for Launching and Recovering Submersibles;” U.S. Pat. No. 7,546,814 to Said entitled “Launch and Recovery Ramp System;” U.S. Pat. No. 7,475,649 to Shepherd entitled “Davit System for Small Boats;” 7,231,882 to Zander entitled “Support Assembly for Loading and Securing a Tender;” U.S. Pat. No. 7,156,036 to Seiple entitled “Launch and Recovery System;” U.S. Pat. No. 6,431,105 to Haram entitled “Method for Bringing People in Life Boats Aboard a Support Vessel and a Support Vessel;” U.S. Pat. No. 5,483,912 to Thomas entitled “Small Craft Carrier;” and United States Patent Office Pre-Grant Publication No. 2008/0202405 to Kern entitled “Launch and Recovery Devices for Water Vehicles and Methods of Use.” However, none of these references has adequately solved the above-described needs. For the forgoing reasons, there is a need for an improved method of launching and retrieving seismic equipment from a vessel.

### SUMMARY

Disclosed herein are embodiments of the present invention that address the needs described above by providing devices and methods that provide safe and efficient seismic testing. An apparatus having features of the present invention includes a device for the launching, testing, and retrieving of seismic equipment which is referred to in various descriptions of the invention as a “launch device” for the sake of brevity.

An apparatus for seismic testing having features of the present invention includes a seismic device capable of producing, recording, or transmitting seismic activity; a marine vessel; a support structure; at least one movable brace capable of securing the seismic device in a fixed position relative to the support structure; and a line tethering the support structure to the seismic device. In that apparatus, the support structure is attached to the marine vessel, the support structure supports the weight of the seismic device, the support structure is actuated for movement relative to the marine vessel, and the seismic device is capable of being launched into water surrounding the marine vessel by providing slack to the line. In separate but related embodiments of the invention, the line is attached to a winch at the support structure, the winch is capable of providing enough line to allow tethered operation of the seismic device at a position significantly removed from the marine vessel and capable of returning the seismic device to the marine vessel, the seismic device is a submersible seismic device, the support structure is attached to the marine vessel at a pivot, the support structure is capable of rotating about the pivot with respect to the marine vessel, and there are two movable braces.

A method of performing seismic testing from a marine vessel having features of the present invention includes: loading a seismic device onto a base of a support structure wherein the seismic device is capable of producing, recording, or transmitting seismic activity and wherein the support structure comprises at least one immobilizing device capable of securing the seismic device in a first fixed position relative to the support structure, which comprises an actuator capable of moving the support structure relative to the marine vessel; tethering the seismic device to the support structure with a line; operating the at least one immobilizing device to secure the seismic device in a second fixed position relative to the base; operating the actuator to move the center of gravity of the seismic device away from the center of gravity of the marine vessel, operating the at least one immobilizing device to release the seismic device from the second fixed position relative to the base; and lowering the seismic device into water by either releasing the tether or providing slack to the tether. In separate but related embodiments of the invention the at least one immobilizing device is at least one movable brace, the at least one immobilizing device is at least two moveable braces that press against the seismic device in opposite directions, the line is fed from a winch and the winch is capable of providing enough line to the tether to allow operation of the seismic device at a position significantly removed from the marine vessel, the winch is operated to return the seismic device to the support structure, the operating of the actuator to move the center of gravity of the seismic device away from the center of gravity of the marine vessel causes the center of gravity of the seismic device to move from over the marine vessel to over the water, the tethering of the seismic device to the support structure acts to deter the movement of the seismic device relative to the support structure, the seismic device is a submersible seismic device with a buoy, the operation of the actuator to move the center of gravity of the seismic device away from the center of gravity of the marine vessel causes the support structure to rotate on a hinge, and the actuator contains a hydraulic piston.

A further method of performing seismic testing from a marine vessel having features of the present invention includes steps described above and additional steps including allowing the seismic device to separate from the marine vessel and arrive at a testing location; operating the seismic device to produce, record, or transmit seismic activity; operating the winch to reel in the line and draw the seismic device onto the base of the support structure; operating the at least one immobilizing device to secure the seismic device in a third fixed position relative to the base; and operating the actuator to move center of gravity of the seismic device toward the center of gravity of the marine vessel. In a still further method of performing seismic testing from a marine vessel the first fixed position, the second fixed position, and the third fixed position are substantially the same position.

### BRIEF DESCRIPTION OF THE DRAWINGS

FIG. 1 shows a side view of the launch device in the pre-launch position.

FIG. 2 shows a side view of the launch device in the process of launching seismic equipment.

FIG. 3 shows a side view of the launch device tethered to seismic equipment that has been launched.

FIG. 4 shows a top view of the launch device.

FIG. 5 shows a perspective view of the launch device.

### DETAILED DESCRIPTION

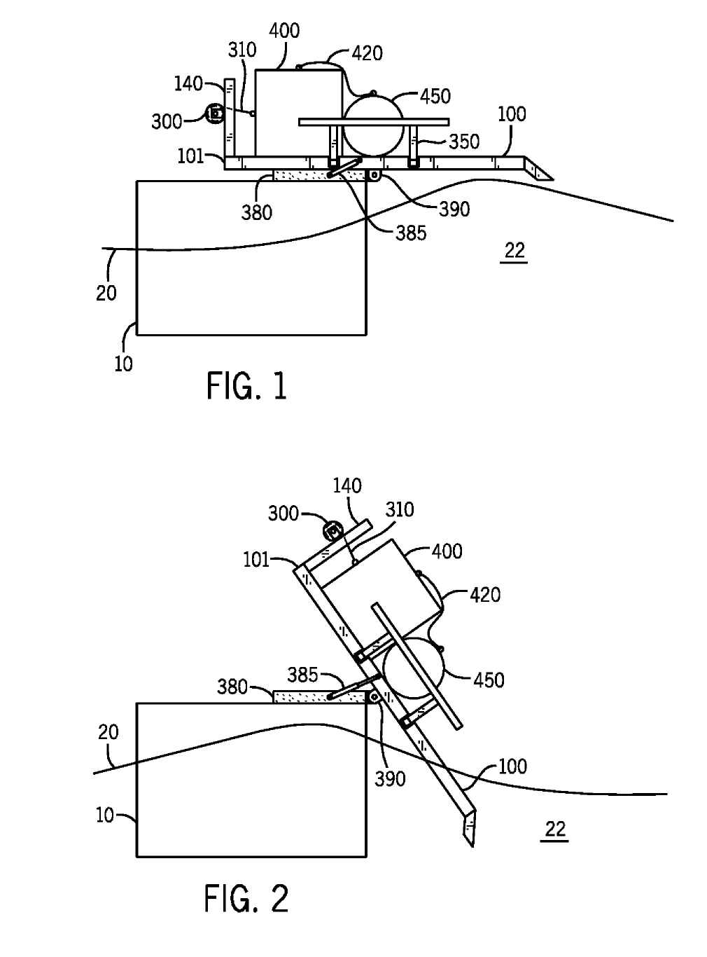

Now referring to FIG. 1 of the drawings, a launch device is mounted to a vessel 10 at a position accessible to the water 22 indicated by water line 20. The launch device is positioned with respect to the edge of vessel 10 such that a significant portion of frame base 100 extends over the water 22 and the remainder of frame base 100 is above vessel 10. Vessel 10 may be any variety of nautical or marine vessels including boats, ships, barges, and oil and gas platforms. Frame base 100 is connected to frame base support 380 by hinge 390 which restrains the movement of frame base 100 to pivoting about frame base 100. Frame base 100 may be also be characterized as a support structure having a base 101 and a rear frame 140 Hydraulic lift 385 actuates the movement of frame base 100 about hinge 390. Hydraulic lift 385 may take the form of a hydraulic piston. When frame base 100 is in a position parallel to frame base support 380, frame base 100 may be secured to frame base support 380 by a locking pin (not shown). FIG. 1 shows frame base 100 parallel to frame base support 380. This position is the “pre-launch position” for the launch device.

Seismic device 400, buoy 450, and buoy cable 420 rest on frame base 100. Significant movement of seismic device 400 in the direction of or away from rear frame 140 is restrained by cable 310 and rear frame 140. Significant side to side movement of seismic device 400 and buoy 450 is restrained by side rail 350 which may take the form of a moveable brace or a sliding rail and may further be characterized as an immobilizing device. Side rail 350 preferably contacts seismic device 400 at a height that is roughly equivalent to the height of the center of gravity of seismic device 400 when seismic device 400 is resting on the base 101 of frame base 100. Slack may be provided or taken from cable 310 by the operation of winch 300.

FIG. 2 of the drawings shows a side view of the launch device in a launching position. The term “launching position” refers to the fact that frame base 100 is in an inclined position with respect to frame base support 380. The launching position is attained by actuation of hydraulic lift 385.

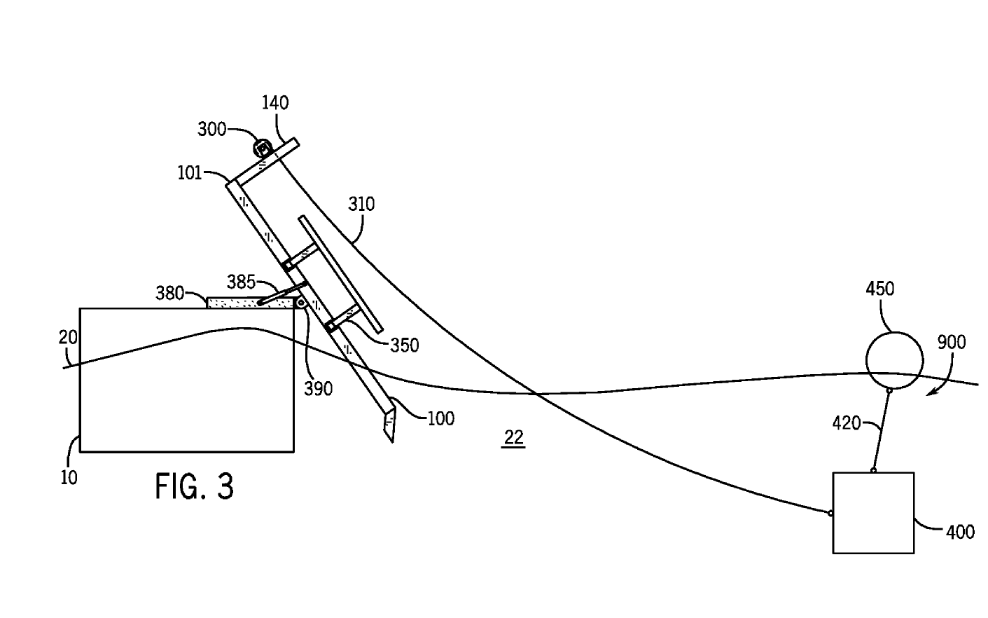

FIG. 3 of the drawings shows a side view of the launch device in which seismic device 400 has been launched and is floating with the assistance of buoy 450 and buoy cable 420. Cable 310 tethers seismic device 400 to winch 300 and the launch device allowing seismic device 400 to float at testing location 900. Testing location 900 may be at a location that is significantly removed from the marine vessel.

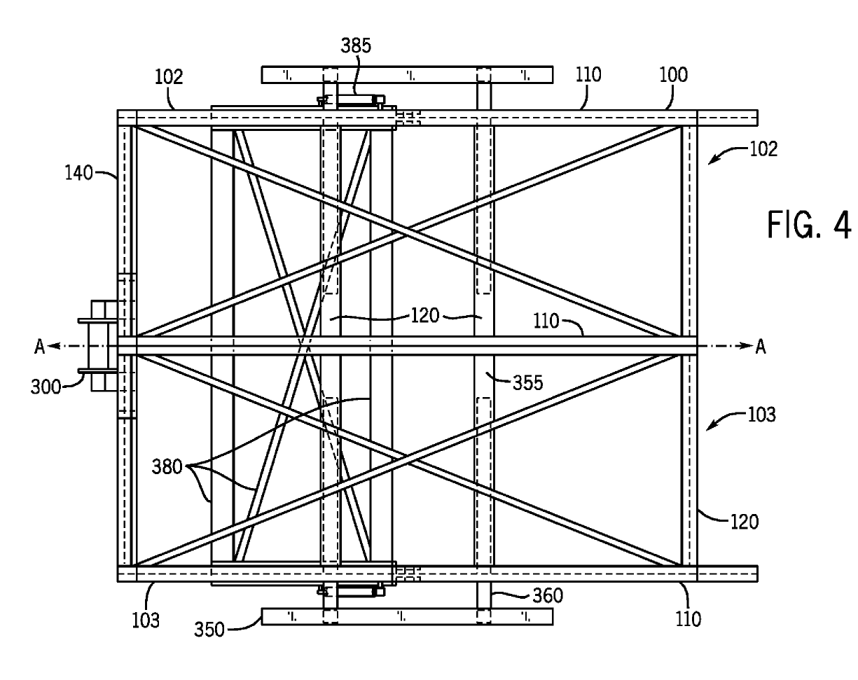

FIG. 4 of the drawings shows a top view of the launch device. Frame base 100 is made up of a base 101 and a rear frame 140. Base 101 of frame base 100 may be divided along the axis A in such a way that base 101 contains two sections that substantially mirror each other about axis A and are joined at axis A. Those sections are labeled in FIG. 4 as first base section 102 and second base section 103. Both first base section 102 and second base section 103 contain multiple frame base width span members 120 and multiple frame base lengthwise members 110. The frame base width span members 120 and frame base lengthwise members 110 are fastened to one another. First base section 102 and second base section 103 are removably fastened to one another. Winch 300 is supported by rear frame 140 which attaches to base 101 of frame base 100. Frame base support 380 supports frame base 100 in the manner described above. Side rails 350 are attached to slide rail support tube 360 which is slidably situated within slide rail guide tube 355. Slide rail 350 slides toward and away from the space above frame base 100 in such a way that it is able to restrain the movement of seismic device 400 and release seismic device 400 as needed. Slide rail 350 may be actuated hydraulically or by other means and may be secured by a locking pin or equivalent securing means.

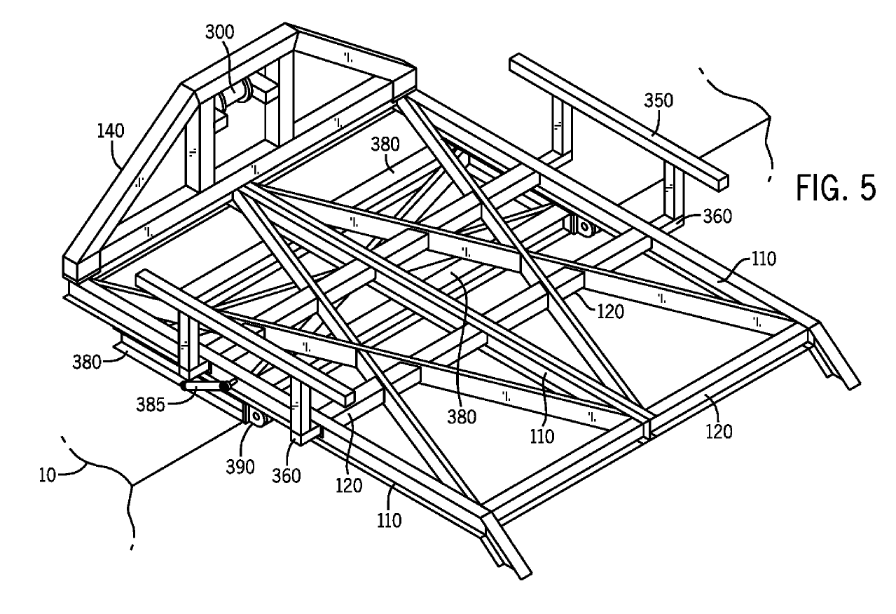

FIG. 5 is a perspective view of the launch device. Each of the elements shown in FIG. 5 is described above.

Operation of the launch device may be accomplished by first loading seismic device 400 and buoy 450 onto frame base 100. Second, slide rails 350 are slid against the seismic device 400. With cable 310 attached and taut, hydraulic lift 385 is then actuated such that frame base 100 pivots about hinge 390 in a way that raises rear frame 140 with respect to vessel 10. The actuation of hydraulic lift 385 is stopped when frame base 100 is in or near the water 22. This position is the launching position. Upon reaching the launching position, slide rails 350 are withdrawn from contact with seismic device 400. Winch 300 is actuated to provide slack to cable 310 allowing seismic device 400 and buoy 450 to enter the water 22 and ultimately drift away from vessel 10. Seismic device 400 may then be operated when in the correct position for a seismic test. The details of operation of the seismic device are according to known procedures or according to procedures appropriate to the specific equipment being used. Retrieval of seismic device 400 is accomplished by reversing the process. First, winch 300 reels seismic device 400 and buoy 450 onto frame base 100. Then, side rails 350 are pressed against seismic device 400 securing it in place. Finally, hydraulic lift 385 is actuated to bring frame base 100 into the pre-launch position, parallel with frame base support 380. Because this operation does not use a crane, many safety concerns associated with the launching of seismic device 400 are avoided.

The launch device may be broken up into its individual components to facilitate shipping to and from the vessel. The launch device may be broken up into individual components including first base section 102, second base section 103, and rear frame 140. These individual sections and the other components of the device are sized and configured for easy shipping including shipping over the highway with a tractor-trailer. Each of the pieces of the launch device are less than 8 feet 6 inches in either length, width, or height. These shipping characteristics allow for shipment to and from the vessel as component parts with assembly and disassembly occurring on the vessel.

The term “vessel” as used herein is used to broadly denote any mobile or non-mobile apparatus capable of operation in the open water and capable of carrying seismic equipment. Examples of apparatus that may be characterized as a vessels include boats, ships, and oil and gas platforms.

Any and all reference to patents, documents and other writings contained herein shall not be construed as an admission as to their status with respect to being or not being prior art. It is understood that the array of features and embodiments taught herein may be combined and rearranged in a large number of additional combinations not directly disclosed, as will be apparent to one having skill in the art and that various embodiments of the invention may have less than all of the benefits and advantages disclosed herein.

There are, of course, other alternate embodiments which are obvious from the foregoing descriptions of the invention, which are intended to be included within the scope of the invention, as defined by the following claims.

I claim:

1. An apparatus for seismic testing comprising:
(a) a seismic device capable of producing, recording, or transmitting seismic activity;
(b) a marine vessel;
(c) a support structure;
(d) at least one movable brace capable of securing the seismic device in a fixed position relative to the support structure;
(e) a line tethering the support structure to the seismic device;
(f) wherein the support structure is attached to the marine vessel;
(g) wherein the support structure supports the weight of the seismic device;
(h) wherein the support structure is actuated for movement relative to the marine vessel;
(i) wherein the seismic device is capable of being launched into water surrounding the marine vessel by providing slack to the line.

2. The apparatus of claim 1 wherein the line is attached to a winch at the support structure.

3. The apparatus of claim 2 wherein the winch is capable of providing enough line to allow tethered operation of the seismic device at a position significantly removed from the marine vessel and capable of returning the seismic device to the marine vessel.

4. The apparatus of claim 1 wherein the seismic device is a submersible seismic device.

5. The apparatus of claim 1 wherein the support structure is attached to the marine vessel at a pivot.

6. The apparatus of claim 5 wherein the support structure is capable of rotating about the pivot with respect to the marine vessel.

7. The apparatus of claim 1 wherein the at least one moveable brace is two movable braces.

8. A method of performing seismic testing from a marine vessel comprising:
(a) loading a seismic device onto a base of a support structure;
(b) wherein the seismic device is capable of producing, recording, or transmitting seismic activity;
(c) wherein the support structure further comprises:
i) at least one immobilizing device capable of securing the seismic device in a first fixed position relative to the support structure;
ii) an actuator capable of moving the support structure relative to the marine vessel;
(d) tethering the seismic device to the support structure with a line;
(e) operating the at least one immobilizing device to secure the seismic device in a second fixed position relative to the base;
(f) operating the actuator to move the center of gravity of the seismic device away from the center of gravity of the marine vessel;
(g) operating the at least one immobilizing device to release the seismic device from the second fixed position relative to the base; and
(h) lowering the seismic device into water by either releasing the tether or providing slack to the tether.

9. The method of claim 8 wherein the at least one immobilizing device is at least one movable brace.

10. The method of claim 8 wherein the at least one immobilizing device is at least two moveable braces that press against the seismic device in opposite directions.

11. The method of claim 8 wherein the line is fed from a winch and the winch is capable of providing enough additional line to the tether to allow operation of the seismic device at a position significantly removed from the marine vessel.

12. The method of claim 11 further comprising the step of operating the winch to return the seismic device to the support structure.

13. The method of claim 8 wherein the operating of the actuator to move the center of gravity of the seismic device away from the center of gravity of the marine vessel causes the center of gravity of the seismic device to move from over the marine vessel to over the water.

14. The method of claim 8 wherein the tethering of the seismic device to the support structure acts to deter the movement of the seismic device relative to the support structure.

15. The method of claim 8 wherein the seismic device is a submersible seismic device with a buoy.

16. The method of claim 8 wherein the operation of the actuator to move the center of gravity of the seismic device away from the center of gravity of the marine vessel causes the support structure to rotate on a hinge.

17. The method of claim 8 wherein the actuator contains a hydraulic piston.

18. The method of claim 11 further comprising the steps of:
(a) allowing the seismic device to separate from the marine vessel and arrive at a testing location;
(b) operating the seismic device to produce, record, or transmit seismic activity;
(c) operating the winch to reel in the line and draw the seismic device onto the base of the support structure;
(d) operating the at least one immobilizing device to secure the seismic device in a third fixed position relative to the base; and
(e) operating the actuator to move center of gravity of the seismic device toward the center of gravity of the marine vessel.

19. The method of claim 18 wherein the first fixed position, the second fixed position, and the third fixed position are substantially the same position.

20. A method of performing seismic testing from a marine vessel comprising:
(a) loading a seismic device onto a base of a support structure;
(b) wherein the seismic device is capable of producing, recording, or transmitting seismic activity;
(c) wherein the support structure further comprises:
i) a rear support attached to said base;
ii) two sliding rails that act in opposite directions and are sized and configured to contact the seismic device at a height that roughly equivalent to the height of the center of gravity of the seismic device when the seismic device is resting on the base of the support structure, the sliding rails being capable of securing the seismic device in a first fixed position relative to the support structure;
iii) at least two hydraulic sliding rail actuators that act to move the two sliding rails toward and away from each other;
iv) an actuator capable of moving the support structure relative to the marine vessel;
v) a line fed from a winch wherein the winch is capable of reeling out enough of the line to allow operation of the seismic device at a position significantly removed from the marine vessel and where in the winch is attached to the rear support;
(d) tethering the seismic device to the support structure with the line such that the position of the seismic device is substantially fixed in a first fixed position on the base;
(e) operating the two sliding rails to secure the seismic device in a second fixed position relative to the base;
(f) operating the actuator to move the center of gravity of the seismic device away from the center of gravity of the marine vessel such that the movement causes the center of gravity of the seismic device to move from over the marine vessel to being over water;
(g) operating the two sliding rails to release the seismic device from the second fixed position relative to the base;
(h) lowering the seismic device into water by either releasing the tether or providing slack to the tether;
(i) allowing the seismic device to separate from the marine vessel and arrive at a testing location;
(j) operating the seismic device to produce, record, or transmit seismic activity;
(k) operating the winch to reel in the line and draw the seismic device onto the base of the support structure;
(l) operating the two sliding rails to secure the seismic device in a third fixed position relative to the base; and
(m) operating the actuator to move center of gravity of the seismic device toward the center of gravity of the marine vessel; and
(n) wherein the first fixed position, the second fixed position, and the third fixed position are substantially the same position relative to the base.
